(19) United States
(12) Patent Application Publication
(10) Pub. No.: US 2018/0336058 A1
(43) Pub. Date: Nov. 22, 2018

(54) APPARATUS FOR PROVIDING VIRTUAL DESKTOP SERVICE AND METHOD FOR THE SAME

(71) Applicant: ELECTRONICS AND TELECOMMUNICATIONS RESEARCH INSTITUTE, Daejeon (KR)

(72) Inventors: Sun-Wook KIM, Hwaseong (KR); Santoso Ganis ZULFA, Daejeon (KR); Dong-Jae KANG, Daejeon (KR); Song-Woo SOK, Daejeon (KR); Myeong-Hoon OH, Daejeon (KR); Young-Woo JUNG, Daejeon (KR); Hyun-Hwa CHOI, Daejeon (KR)

(21) Appl. No.: 15/975,618

(22) Filed: May 9, 2018

(30) Foreign Application Priority Data
May 19, 2017 (KR) 10-2017-0062139

(51) Int. Cl. G06F 9/455; G06F 9/451

(52) U.S. Cl. CPC G06F 9/45558; G06F 9/452; G06F 2009/45587; G06F 2009/45595; G06F 2009/45562

(57) ABSTRACT

Disclosed herein is a method for providing a virtual desktop service, which includes allocating a host virtual machine based on IaaS of a public cloud in response to a request for a virtual machine based on a public cloud from a service client device, installing a guest hypervisor on the host virtual machine, creating a public virtual machine based on the guest hypervisor, and providing the public virtual machine to the service client device.

### CROSS REFERENCE TO RELATED APPLICATION

This application claims the benefit of Korean Patent Application No. 10-2017-0062139, filed May 19, 2017, which is hereby incorporated by reference in its entirety into this application.

### BACKGROUND OF THE INVENTION

### 1. Technical Field

The present invention relates generally to a virtual desktop service system based on a hybrid cloud that supports interworking of cloud infrastructure in different regions, and more particularly to an apparatus and method through which a virtual desktop service provided in an on-premise environment may be provided in a public cloud environment.

### 2. Description of the Related Art

Recently, requirements for cloud service extension based on a hybrid cloud, which is built by combining a public cloud with a private cloud, are growing. The term “hybrid cloud” refers to a combination of a cloud service with a group of actual servers, and the implementation of a hybrid cloud enables a virtual machine to remotely run on hardware (a cloud platform, or the like) that is not locally managed.

Public cloud services provided by cloud service providers on the Internet, such as Amazon, Google, and Microsoft, may be advantageous in various aspects, such as accessibility, performance, and the like, but there may be concern about management and security from the point of view of companies that use the service.

The term “private cloud” refers to a cloud service that is used only by a single company or organization. That is, a company or an organization autonomously constructs a cloud in an on-premise environment, so that departments and employees may use the cloud service. Contrary to a public cloud, a private cloud is advantageous from the aspects of management, maintaining confidentiality of a company, and the like, but accessibility and scalability, generally known as the advantages of the cloud, may be limited.

In order to compensate for the disadvantages of a public cloud service and a private cloud service with the advantages thereof, a hybrid cloud has been proposed. A hybrid cloud is configured such that a public cloud or a private cloud may be selectively used depending on the purpose for which the system is used, that is, a public cloud is used where performance and accessibility are considered important, but a private cloud is used where flexibility and security are considered important.

Meanwhile, a virtual desktop service is a service for providing a hard disk for storing data, applications, and the like in a cloud space, and users may use a virtual machine running on a virtual desktop server by accessing a client system connected thereto.

Generally, a virtual desktop service is configured such that, in a private cloud, a virtual server computing environment is formed by virtualizing computing resources (a CPU, memory, a disk, a network, and the like) of a bare metal server, and is delivered to users using a virtual desktop transfer protocol.

However, public cloud services provided by cloud service providers, such as Amazon, Google, and Microsoft, provide virtual machines by default, and prevent access to a bare metal server. Therefore, it is impossible to configure and provide a virtual desktop service in the same manner as in a private cloud. Of course, some cloud service providers allow users to rent bare metal servers, but this may be costly and limit scalability.

When a conventional virtual desktop service system based on the virtualization of a bare metal server is configured in a private cloud environment, service may be provided after a corresponding service library is installed at the OS kernel level based on an on-premise physical server. However, in the case of a public cloud, in which a cloud service is provided based on a virtual machine, the corresponding service library cannot be installed because access to a bare metal server is prevented. Accordingly, in order to provide a virtual desktop service based on a hybrid cloud, which is a combination of a private cloud and a public cloud, it is necessary to install a kernel-level virtualization module based on a virtual machine and to install a service library.

Therefore, a technique for enabling a virtual desktop service to be provided in both private and public cloud environments is required. In connection with this, Korean Patent No. 10-1554554 discloses a technology related to “Method for driving virtual machine and system.”

The above-described information about the related art has been retained by the inventors for the purpose of developing the present invention or was obtained during the process of developing the present invention. Also, it should be appreciated that this information did not necessarily belong to the public domain before the patent filing date of the present invention.

### SUMMARY OF THE INVENTION

An object of the present invention is to provide an apparatus and method for providing a virtual desktop service based on a hybrid cloud using a nested virtualization technique, through which a virtual desktop service may be provided in both private and public cloud environments.

An embodiment of the present invention provides a method for providing a virtual desktop service, which includes allocating a host virtual machine based on Infrastructure-as-a-Service (IaaS) of a public cloud in response to a request for a virtual machine based on a public cloud from a service client device; installing a guest hypervisor on the host virtual machine; creating a public virtual machine based on the guest hypervisor; and providing the public virtual machine to the service client device.

Here, the method may further include installing a host hypervisor in response to a request for a virtual machine based on a private cloud from the service client device; creating a private virtual machine based on the host hypervisor; and providing the private virtual machine to the service client device.

Here, the method may further include connecting a virtual desktop with the service client device through a virtual desktop service connection manager.

Here, installing the guest hypervisor may include activating a host-passthrough function in order to enable the host virtual machine to directly access a hardware resource.

Here, the method may support a web-based virtual desktop service in order to enhance security.

Here, the web-based virtual desktop service may be based on HTML5.

Another embodiment of the present invention provides an apparatus for providing a virtual desktop service, which includes a communication unit for receiving a request for a virtual machine based on a public cloud from a service client device, and providing a public virtual machine to the service client device in response to the request; and a public virtual machine management unit for allocating a host virtual machine based on Infrastructure-as-a-Service (IaaS) of a public cloud in response to the request for the virtual machine based on the public cloud, installing a guest hypervisor on the host virtual machine, and creating a public virtual machine based on the guest hypervisor.

Here, the communication unit may receive a request for a virtual machine based on a private cloud from the service client device, and may provide a private virtual machine to the service client device in response to the request. The apparatus may further include a private virtual machine management unit for installing a host hypervisor and creating a private virtual machine based on the host hypervisor in response to the request for the virtual machine based on the private cloud.

The apparatus may further include a virtual desktop service connection management unit for connecting a virtual desktop with the service client device.

Here, the host virtual machine may use a host-passthrough function for direct access to a hardware resource of the apparatus.

Here, the apparatus may further include a web service management unit for supporting a web-based virtual desktop service in order to enhance security.

Here, the web-based virtual desktop service may be based on HTML5.

A further embodiment of the present invention provides a service client device, which includes a communication unit for sending a request for a virtual machine based on a public cloud to a virtual desktop service provision apparatus and being provided with a public virtual machine from the virtual desktop service provision apparatus; and a virtual machine execution unit for running the public virtual machine, wherein in response to the request for the virtual machine based on the public cloud, the virtual desktop service provision apparatus may allocate a host virtual machine based on Infrastructure-as-a-Service (IaaS) of a public cloud, and the public virtual machine may be created based on a guest hypervisor installed on the host virtual machine.

Here, the communication unit may send a request for a virtual machine based on a private cloud to the virtual desktop service provision apparatus and be provided with a private virtual machine from the virtual desktop service provision apparatus, the virtual machine execution unit may run the private virtual machine, and the private virtual machine may be created based on a host hypervisor installed in the virtual desktop service provision apparatus in response to the request for the virtual machine based on the private cloud.

Here, the service client device may be connected with a virtual desktop through a virtual desktop service connection management unit of the virtual desktop service provision apparatus.

Here, the host virtual machine may use a host-passthrough function in order to directly access a hardware resource of the virtual desktop service provision apparatus.

Here, the communication unit may be provided with a web-based virtual desktop service that is supported through a web service management unit of the virtual desktop service provision apparatus in order to enhance security, and the virtual machine execution unit may support the web-based virtual desktop service.

Here, the web-based virtual desktop service may be based on HTML5.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view that shows the configuration of a system for providing a virtual desktop service according to an embodiment of the present invention;

FIG. 2 is a view that shows an example of a system for providing a virtual desktop service according to an embodiment of the present invention;

FIG. 3 is a view that shows a method for providing a virtual desktop service according to an embodiment of the present invention;

FIG. 4 is a view that shows the structure of a service server in a public cloud according to an embodiment of the present invention;

FIG. 5 is a view that shows the structure of a service server in a public cloud according to an embodiment of the present invention;

FIG. 6 is a view that shows the structure of a service server in a public cloud according to an embodiment of the present invention;

FIG. 7 is a block diagram that shows the configuration of an apparatus for providing a virtual desktop service according to an embodiment of the present invention;

FIG. 8 is a block diagram that shows the configuration of a service client device according to an embodiment of the present invention; and

FIG. 9 is an embodiment of the present invention implemented in a computer system.

### DESCRIPTION OF THE PREFERRED EMBODIMENTS

The present invention may be variously changed, and may have various embodiments, and specific embodiments will be described in detail below with reference to the attached drawings. The effects and features of the present invention and methods of achieving them will be apparent from the following exemplary embodiments, which will be described in more detail with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

However, the present invention is not limited to the embodiments to be described below, but all or some of the embodiments may be selectively combined and configured, so that the embodiments may be modified in various ways. It will be understood that, although the terms “first,” “second,” etc. may be used herein to describe various elements, these elements are not intended to be limited by these terms. These terms are only used to distinguish one element from another element. Also, a singular expression includes a plural expression unless a description to the contrary is specifically pointed out in context. Also, it should be understood that terms such as “include” or “have” are merely intended to indicate that features, components, parts, or combinations thereof are present, and are not intended to exclude the possibility that one or more other features, components, parts, or combinations thereof will be present or added.

Hereinafter, embodiments of the present invention will be described in detail with reference to the accompanying drawings. In the following description of the present invention, the same reference numerals are used to designate the same or similar elements throughout the drawings, and repeated descriptions of the same components will be omitted.

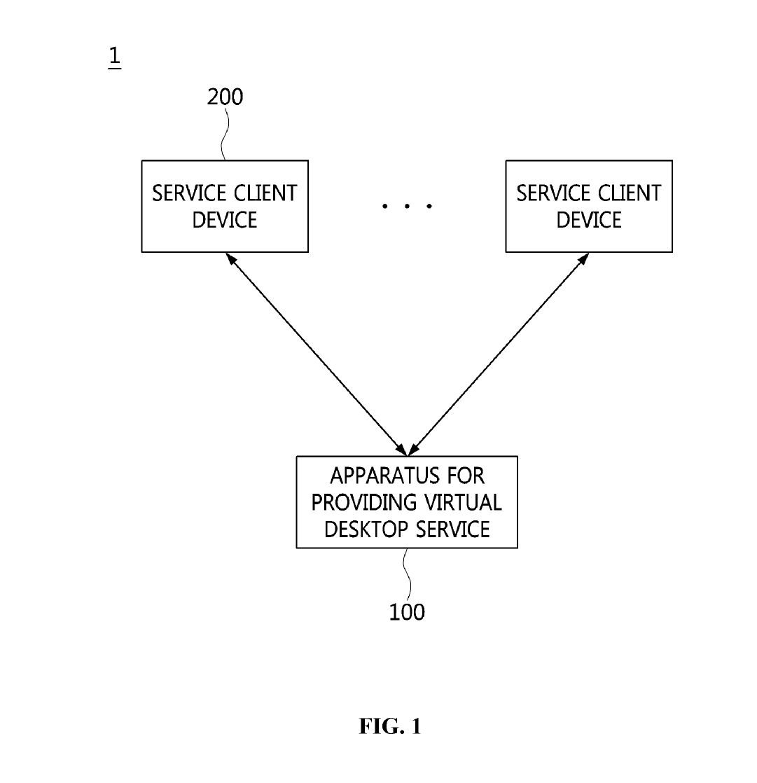

FIG. 1 is a view that shows the configuration of a system for providing a virtual desktop service according to an embodiment of the present invention.

Referring to FIG. 1, in the system 1 for providing a virtual desktop service according to an embodiment of the present invention, a virtual desktop service provision apparatus 100 is interconnected with one or more service client devices 200.

The virtual desktop service provision apparatus 100 according to an embodiment of the present invention receives a request for a virtual machine from the service client device 200. When the received request is a request for a virtual machine based on a public cloud, the virtual desktop service provision apparatus 100 allocates a host virtual machine based on Infrastructure-as-a-Service (IaaS) to a public cloud, installs a guest hypervisor on the host virtual machine, and provides the service client device 200 with a public virtual machine created based on the guest hypervisor.

In an alternative embodiment, when the request for a virtual machine, received from the service client device 200, is a request for a virtual machine based on a private cloud, the virtual desktop service provision apparatus 100 installs a host hypervisor in a public cloud and provides the service client device 200 with a private virtual machine created based on the host hypervisor.

Here, the private virtual machine is a virtual machine provided based on a bare metal server. Accordingly, the private virtual machine corresponds to a virtual desktop service provided in an on-premise environment.

In an alternative embodiment, when a guest hypervisor is installed, the virtual desktop service provision apparatus 100 may activate a host-passthrough function in order to enable a host virtual machine to directly access a hardware resource.

Accordingly, where performance and accessibility are considered more important, a virtual desktop service based on a public cloud may be provided, but where flexibility and security are considered more important, a virtual desktop service based on a private cloud may be provided.

Also, a virtual desktop service provided in an on-premise environment may be provided in a public cloud environment.

In an alternative embodiment, the virtual desktop service provision apparatus 100 may include a virtual desktop service connection management unit for connection between a host virtual machine and the service client device 200.

In an alternative embodiment, the virtual desktop service provision apparatus 100 may provide a web-based virtual desktop service in order to enhance security.

For example, the web-based virtual desktop service may be provided based on HTML5.

The service client device 200 is a device that is capable of requesting a virtual machine, in order to use the same, and of using the provided virtual machine.

For example, the service client device 200 may be a personal computer (PC).

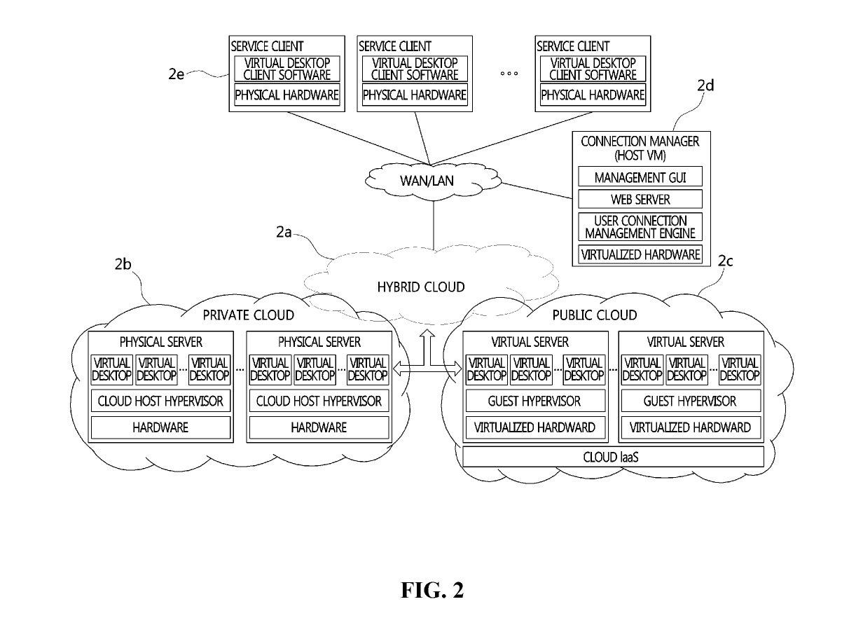

FIG. 2 is a view that shows an example of a system for providing a virtual desktop service according to an embodiment of the present invention.

FIG. 2 shows a system for providing a virtual desktop service in a hybrid cloud environment. The hybrid cloud 2a refers to an environment in which a private cloud 2b is combined with a public cloud 2c.

The present invention intends to enable a virtual desktop service, provided based on a bare metal server in the private cloud 2b, to be provided in the public cloud 2c, which provides only a virtual machine.

A virtual desktop service system based on the private cloud 2b is configured with a physical server, and provides a virtual desktop service after a host hypervisor is installed on the physical server.

Here, the physical server may be a virtual desktop service provision apparatus (100 in FIG. 1).

A virtual desktop service system based on the public cloud 2c is configured with a virtual server, and provides a virtual desktop service after a guest hypervisor is installed on the virtual server.

Here, the virtual server may be a host virtual machine based on IaaS, allocated to the virtual desktop service provision apparatus (100 in FIG. 1). Also, the virtual desktop service provision apparatus (100 in FIG. 1) may be provided by a cloud service provider.

Particularly, a bare-metal virtual desktop service may be provided in the public cloud 2c.

A connection manager 2d is in charge of a service connection between a service client 2e and a virtual desktop. Also, the connection manager manages user information, user authentication, allocation of virtual desktops, a connection state, and the like.

Here, the connection manager may manage virtual desktops and clients using a web-based graphical user interface.

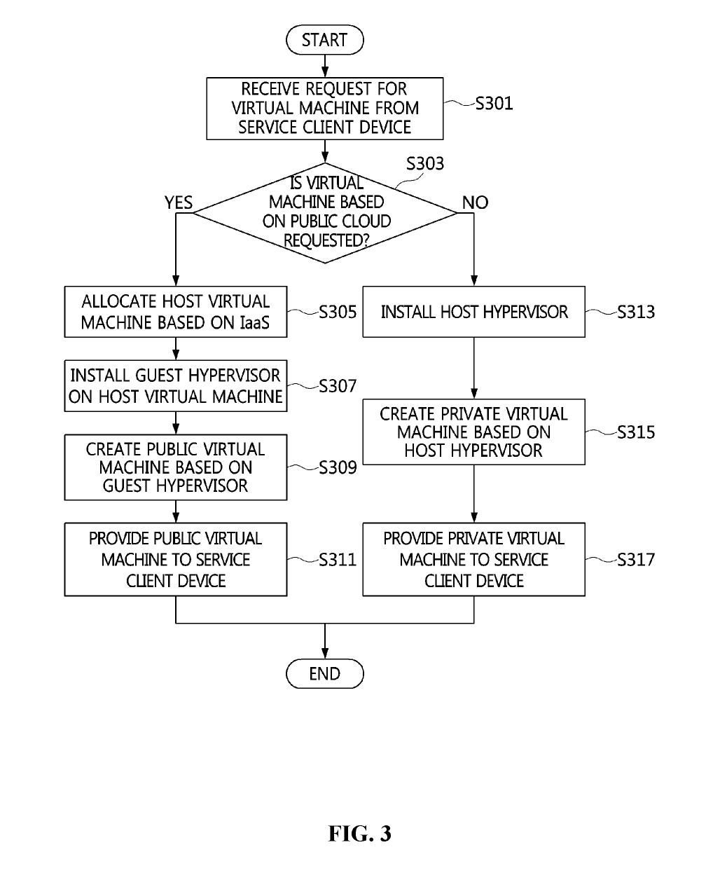

FIG. 3 is a view that shows a method for providing a virtual desktop service according to an embodiment of the present invention.

Referring to FIG. 3, in the method for providing a virtual desktop service according to an embodiment of the present invention, a request for a virtual machine is received from a service client device (200 in FIG. 1) at step S301.

Also, in the method for providing a virtual desktop service according to an embodiment of the present invention, whether the request for a virtual machine is a request for a virtual machine based on a public cloud is determined at step S303.

When it is determined at step S303 that the request for a virtual machine is a request for a virtual machine based on a public cloud, a host virtual machine based on IaaS is allocated at step S305.

Also, in the method for providing a virtual desktop service according to an embodiment of the present invention, a guest hypervisor is installed on the allocated host virtual machine at step S307.

Here, a host-passthrough function may be activated in order for the host virtual machine to directly access a hardware resource.

Here, in the method for providing a virtual desktop service according to an embodiment of the present invention, a virtual desktop service connection manager for connection with the service client device (200 in FIG. 1) may be installed on the host virtual machine.

Also, in the method for providing a virtual desktop service according to an embodiment of the present invention, a public virtual machine is created based on the guest hypervisor at step S309.

Also, in the method for providing a virtual desktop service according to an embodiment of the present invention, the created public virtual machine is provided to the service client device (200 in FIG. 1) at step S311.

When it is determined at step S303 that the request for a virtual machine is not a request for a virtual machine based on a public cloud, a host hypervisor is installed at step S313 because it is determined that the request for a virtual machine is a request for a virtual machine based on a private cloud.

Also, in the method for providing a virtual desktop service according to an embodiment of the present invention, a private virtual machine is created based on the host hypervisor at step S315.

Also, in the method for providing a virtual desktop service according to an embodiment of the present invention, the created private virtual machine is provided to the service client device (200 in FIG. 1) at step S317.

Here, in the method for providing a virtual desktop service according to an embodiment of the present invention, a web-based virtual desktop service may be provided in order to enhance security.

For example, the web-based virtual desktop service may be provided based on HTML5.

Accordingly, any of a private virtual machine and a public virtual machine may be provided depending on the user's need, and a user may use a desired virtual machine in consideration of expenses, space, performance, and the like.

In an alternative embodiment, among the above steps S301, S303, S305, S307, S309, S311, S313, S315, and S317, installing a guest hypervisor at step S307 and creating a public virtual machine at step S309 may be performed simultaneously.

In an alternative embodiment, among the above steps S301, S303, S305, S307, S309, S311, S313, S315, and S317, creating a public virtual machine at step S309 and providing a public virtual machine to a service client device at step S311 may be performed simultaneously.

In an alternative embodiment, among the above steps S301, S303, S305, S307, S309, S311, S313, S315, and S317, installing a host hypervisor at step S313 and creating a private virtual machine at step S315 may be performed simultaneously.

In an alternative embodiment, among the above steps S301, S303, S305, S307, S309, S311, S313, S315, and S317, creating a private virtual machine at step S315 and providing a private virtual machine to a service client device at step S317 may be performed simultaneously.

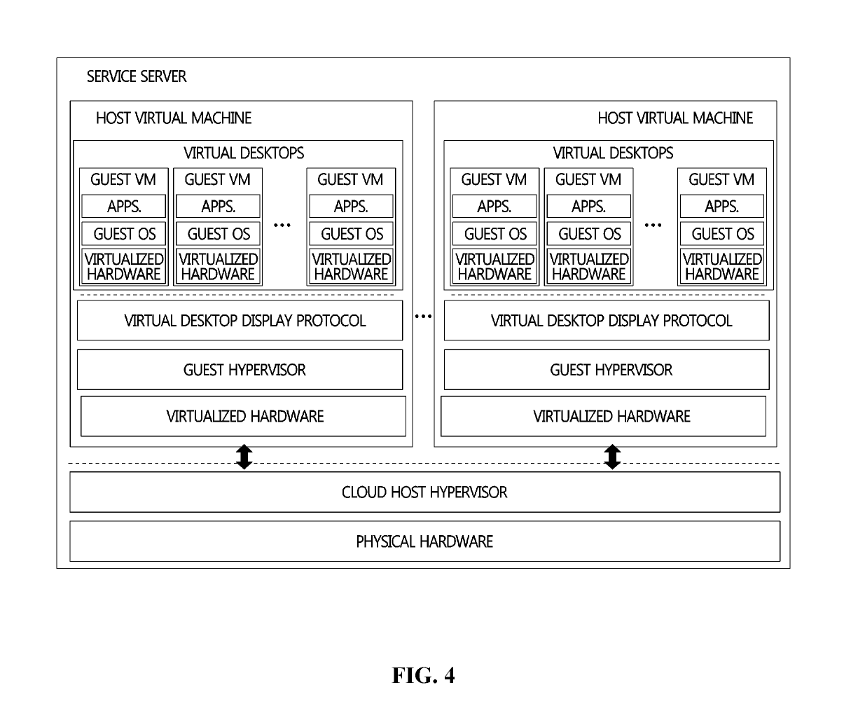

FIG. 4 is a view that shows the structure of a service server in a public cloud according to an embodiment of the present invention.

Referring to FIG. 4, the service server in a public cloud may be provided by a cloud service provider, and may create a host virtual machine or a public virtual machine.

The host virtual machine is based on a virtual server, and is configured with virtualized hardware, a guest hypervisor, a virtual desktop transfer layer, and a virtual desktop layer.

A host hypervisor abstracts computing resources (a CPU, memory, and I/O devices) of a physical server system, thereby dynamically configuring resources required for higher-level software and allocating the resources thereto. Here, the host hypervisor is installed on a host OS, and creates a host virtual machine.

The host virtual machine is configured with a virtual desktop service server. Also, in order to install a guest hypervisor on the host virtual machine, a host-passthrough function for direct allocation of hardware resources may be activated.

Here, a virtual desktop transfer library is installed on the host virtual machine in which the guest hypervisor is installed, and a guest virtual machine for a virtual desktop service is created, whereby a virtual desktop service may be provided to a user over a network.

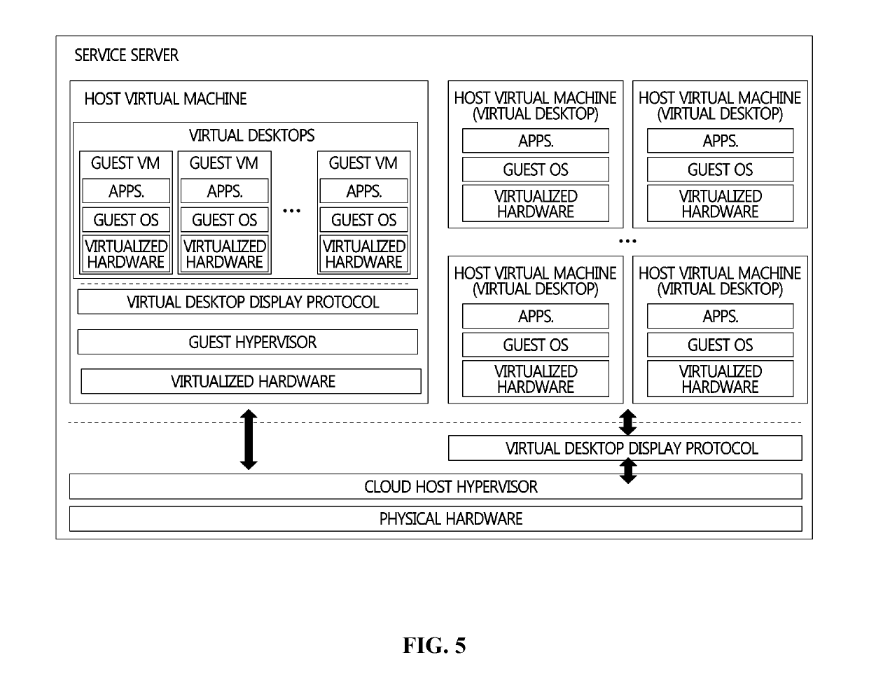

FIG. 5 is a view that shows the structure of a service server in a public cloud according to an embodiment of the present invention.

FIG. 5 shows the extended structure of the service server in the public cloud illustrated in FIG. 4, and shows the structure of the service server in a public cloud for providing a hybrid virtual desktop service.

Referring to FIG. 5, the service server in a public cloud provides a virtual desktop service based on a host hypervisor and a virtual desktop service based on a guest hypervisor.

Here, the virtual desktop service based on the host hypervisor is provided using a bare metal server based on a public cloud.

The virtual desktop service based on the host hypervisor may be provided by providing host virtual machines created based on the host hypervisor.

Accordingly, the service server of the public cloud may provide a virtual desktop service based on the host hypervisor, which is capable of providing a high-performance service, and a virtual desktop service based on a guest hypervisor, which is efficient from the aspects of scalability and expense.

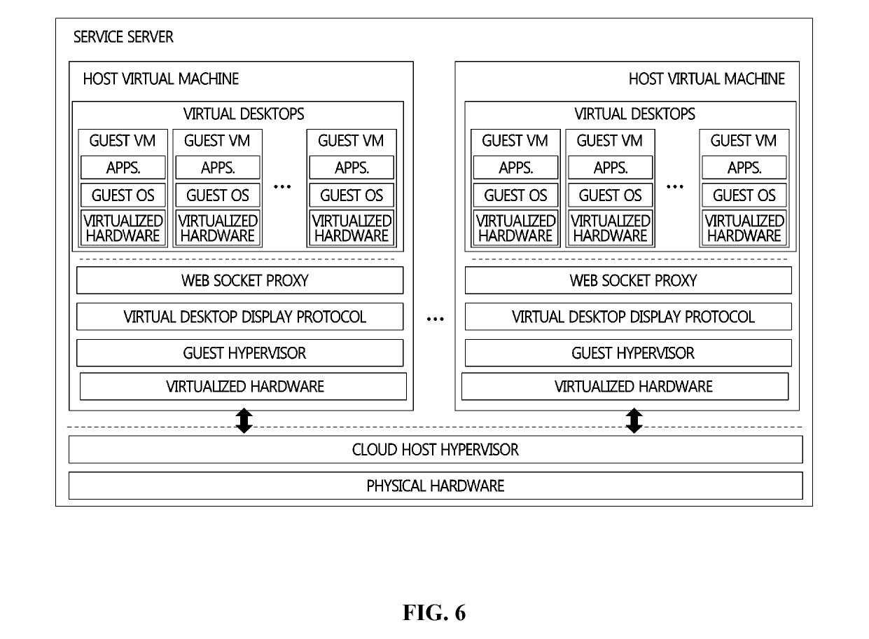

FIG. 6 is a view that shows the structure of a service server in a public cloud according to an embodiment of the present invention.

FIG. 6 shows the extended structure of the service server of the public cloud illustrated in FIG. 4, and shows the structure of the service server in a public cloud for providing a web-based virtual desktop service in order to enhance security.

Referring to FIG. 6, a host virtual machine may include a web socket proxy.

The web socket proxy changes a virtual desktop display protocol, which is to be transmitted to a user over a network, to a web-based service, thereby enabling the use of a general web service port.

Here, the web socket proxy may provide a web service based on HTML5. In this case, a user is required to use a service client based on HTML5.

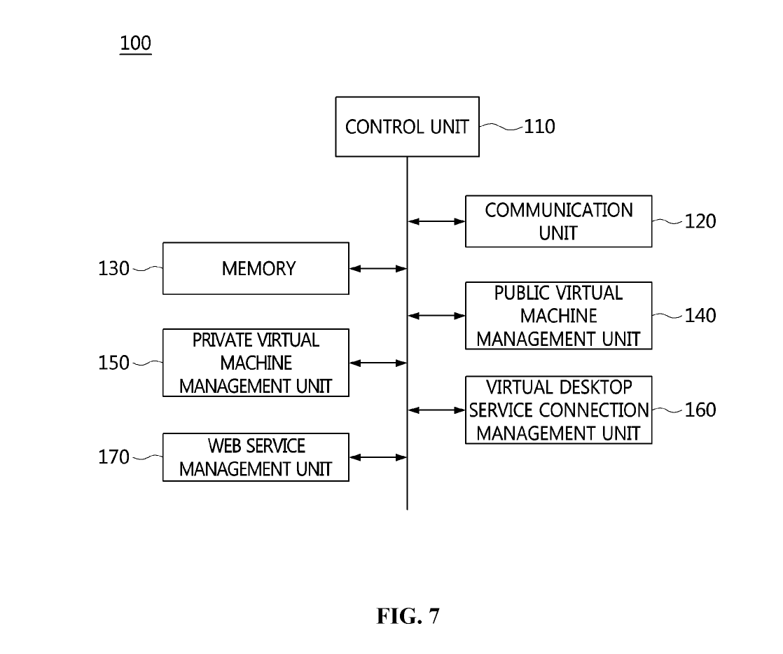

FIG. 7 is a block diagram that shows the configuration of an apparatus for providing a virtual desktop service according to an embodiment of the present invention.

Referring to FIG. 7, the virtual desktop service provision apparatus 100 according to an embodiment of the present invention includes a control unit 110, a communication unit 120, memory 130, a public virtual machine management unit 140, a private virtual machine management unit 150, a virtual desktop service connection management unit 160, a web service management unit 170, and the like.

Specifically, the control unit 110 is a kind of central processing unit, and controls the overall process of providing a virtual desktop service. That is, the control unit 110 may provide various functions by controlling the communication unit 120, the public virtual machine management unit 140, the private virtual machine management unit 150, the virtual desktop service connection management unit 160, the web service management unit 170, and the like.

Here, the control unit 110 may include all kinds of devices capable of processing data, such as a processor and the like. Here, the term ‘processor’ may indicate, for example, a data-processing device embedded in hardware, which has a circuit physically structured for performing functions represented as code or instructions included in a program. An example of such a data-processing device embedded in hardware may include processing devices such as a microprocessor, a central processing unit (CPU), a processor core, a multiprocessor, an application-specific integrated circuit (ASIC), a field-programmable gate array (FPGA), and the like, but the present invention is not limited thereto.

The communication unit 120 provides a communication interface that is necessary in order to send or receive signals between the virtual desktop service provision apparatus 100 and a service client device (200 in FIG. 1).

Here, the communication unit 120 may be a device including hardware and software that are necessary in order to send and receive signals, such as control signals or data signals, through a wired or wireless connection with another network device.

Here, the communication unit 120 may receive a request for a virtual machine based on a public cloud from the service client device (200 in FIG. 1) and provide a public virtual machine to the service client device (200 in FIG. 1).

Here, the communication unit 120 may receive a request for a virtual machine based on a private cloud from the service client device (200 in FIG. 1) and provide a private virtual machine to the service client device (200 in FIG. 1).

The memory 130 functions to temporarily or permanently store data processed by the control unit 110. Here, the memory 130 may include magnetic storage media or flash storage media, but the present invention is not limited thereto.

The public virtual machine management unit 140 allocates a host virtual machine based on IaaS of a public cloud, installs a guest hypervisor on the host virtual machine, and creates a public virtual machine based on the guest hypervisor in response to a request for a virtual machine based on a public cloud from the service client device (200 in FIG. 1).

Here, the host virtual machine may use a host-passthrough function for direct access to a hardware resource of the virtual desktop service provision apparatus 100.

The private virtual machine management unit 150 installs a host hypervisor and creates a private virtual machine based on the host hypervisor in response to a request for a virtual machine based on a private cloud from the service client device (200 in FIG. 1).

The virtual desktop service connection management unit 160 functions to connect the service client device (200 in FIG. 1) with a virtual desktop.

Here, the virtual desktop service connection management unit 160 may manage user information, user authentication, allocation of virtual desktops, a connection state, and the like.

The web service management unit 170 supports a web-based virtual desktop service in order to enhance security.

Here, the web service management unit 170 may support a web-based virtual desktop service based on HTML5.

Here, the web service management unit 170 may manage a virtual desktop and a service client device (200 in FIG. 1) using a web-based graphical user interface.

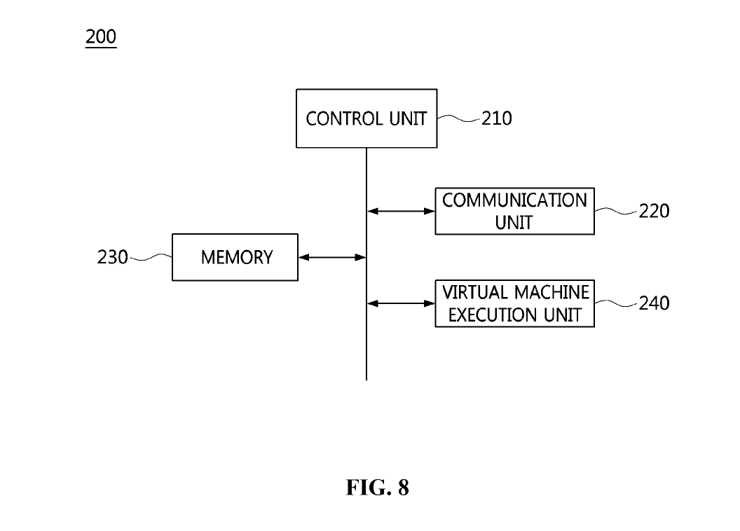

FIG. 8 is a block diagram that shows the configuration of a service client device according to an embodiment of the present invention.

Referring to FIG. 8, the service client device 200 according to an embodiment of the present invention includes a control unit 210, a communication unit 220, memory 230, a virtual machine execution unit 240, and the like.

Specifically, the control unit 210 is a kind of central processing unit, and controls the overall process of running a virtual machine. That is, the control unit 210 may provide various functions by controlling the communication unit 220, the virtual machine execution unit 240, and the like.

Here, the control unit 210 may include all kinds of devices capable of processing data, such as a processor and the like. Here, the term ‘processor’ may indicate, for example, a data-processing device embedded in hardware, which has a circuit physically structured for performing functions represented as code or instructions included in a program. An example of such a data-processing device embedded in hardware may include processing devices such as a microprocessor, a central processing unit (CPU), a processor core, a multiprocessor, an application-specific integrated circuit (ASIC), a field-programmable gate array (FPGA), and the like, but the present invention is not limited thereto.

The communication unit 220 provides a communication interface that is necessary in order to send or receive signals between the service client device 200 and a virtual desktop service provision apparatus (100 in FIG. 1).

Here, the communication unit 220 may be a device including hardware and software that are necessary in order to send and receive signals, such as control signals or data signals, through a wired or wireless connection with another network device.

The memory 230 functions to temporarily or permanently store data processed by the control unit 210. Here, the memory 230 may include magnetic storage media or flash storage media, but the present invention is not limited thereto.

Here, the communication unit 220 may send a request for a virtual machine based on a public cloud to the virtual desktop service provision apparatus (100 in FIG. 1), and may be provided with a public virtual machine from the virtual desktop service provision apparatus (100 in FIG. 1).

Here, in response to the request for a virtual machine based on a public cloud, the virtual desktop service provision apparatus (100 in FIG. 1) allocates a host virtual machine based on IaaS of a public cloud, and a public virtual machine may be created based on a guest hypervisor installed on the host virtual machine.

Here, the host virtual machine may use a host-passthrough function for direct access to a hardware resource of the virtual desktop service provision apparatus (100 in FIG. 1).

Here, the communication unit 220 may send a request for a virtual machine based on a private cloud to the virtual desktop service provision apparatus (100 in FIG. 1), and may be provided with a private virtual machine from the virtual desktop service provision apparatus (100 in FIG. 1).

Here, in response to the request for a virtual machine based on a private cloud, a private virtual machine may be created based on a host hypervisor installed by the virtual desktop service provision apparatus (100 in FIG. 1).

Here the communication unit 220 may be provided with a web-based virtual desktop service that is supported by the web service management unit (170 in FIG. 7) of the virtual desktop service provision apparatus (100 in FIG. 1) in order to enhance security.

Here, the web-based virtual desktop service may be based on HTML5.

The virtual machine execution unit 240 runs a virtual machine.

Here, the virtual machine execution unit 240 may run a public virtual machine provided from the virtual desktop service provision apparatus (100 in FIG. 1).

Here, the virtual machine execution unit 240 may run a private virtual machine provided from the virtual desktop service provision apparatus (100 in FIG. 1).

Here, the virtual machine execution unit 240 may support a web-based virtual desktop service.

Here, the service client device 200 may be connected with a virtual desktop through the virtual desktop service connection management unit (160 in FIG. 7) of the virtual desktop service provision apparatus (100 in FIG. 1).

The above-described embodiment of the present invention may be implemented as program instructions executable by various computer devices, and may be recorded in computer-readable storage media. The computer-readable storage media may separately or collectively include program instructions, data files, data structures, and the like. The program instructions recorded in the computer-readable storage media may be specially designed and configured for the embodiment, or may be available by being well known to computer software experts. Examples of the computer-readable storage media include magnetic media such as a hard disk, a floppy disk and a magnetic tape, optical media such as a CD-ROM and a DVD, and magneto-optical media such as a floptical disk, ROM, RAM, flash memory, and the like, that is, a hardware device specially configured for storing and executing program instructions. Examples of the program instructions include not only machine code made by a compiler but also high-level language code executable by a computer using an interpreter. The above-mentioned hardware device may be configured such that it operates as one or more software modules in order to perform the operations of the embodiment, and vice-versa.

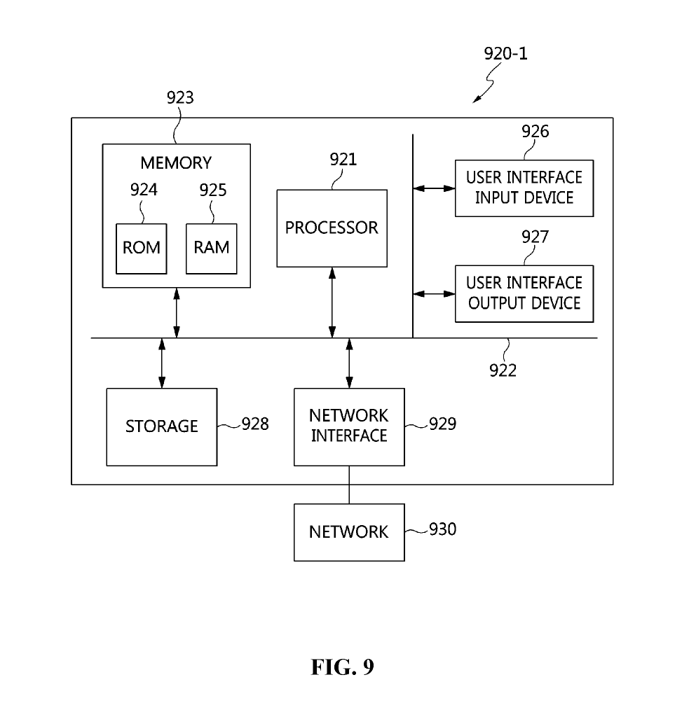

An embodiment of the present invention may be implemented in a computer system, e.g., as a computer readable medium. As shown in in FIG. 9, a computer system 920-1 may include one or more of a processor 921, a memory 923, a user interface input device 926, a user interface output device 927, and a storage 928, each of which communicates through a bus 922. The computer system 920-1 may also include a network interface 929 that is coupled to a network 930. The processor 921 may be a central processing unit (CPU) or a semiconductor device that executes processing instructions stored in the memory 923 and/or the storage 928. The memory 923 and the storage 928 may include various forms of volatile or non-volatile storage media. For example, the memory may include a read-only memory (ROM) 924 and a random access memory (RAM) 925.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

According to the present invention, through the apparatus and method for providing a virtual desktop service based on a hybrid cloud, a virtual desktop service may be provided in private and public cloud environments using a nested virtualization technique, whereby a user may select and use any one of a virtual desktop service based on a private cloud and a virtual desktop service based on a public cloud depending on the circumstances.

Although specific embodiments have been described in the specification, they are not intended to limit the scope of the present invention. For the conciseness of the specification, descriptions of conventional electronic components, control systems, software, and other functional aspects thereof may be omitted. Also, lines connecting components or connecting members illustrated in the drawings show functional connections and/or physical or circuit connections, and may be represented as various functional connections, physical connections, or circuit connections that are capable of replacing or being added to an actual device. Also, unless specific terms, such as “essential”, “important”, or the like, are used, corresponding components may not be absolutely necessary.

Accordingly, the spirit of the present invention should not be construed as being limited to the above-described embodiments, and the entire scope of the appended claims and their equivalents should be understood as defining the scope and spirit of the present invention.

What is claimed is:

1. A method for providing a virtual desktop service, comprising:
allocating a host virtual machine based on Infrastructure-as-a-Service (IaaS) of a public cloud in response to a request for a virtual machine based on a public cloud from a service client device;
installing a guest hypervisor on the host virtual machine;
creating a public virtual machine based on the guest hypervisor; and
providing the public virtual machine to the service client device.

2. The method of claim 1, further comprising:
installing a host hypervisor in response to a request for a virtual machine based on a private cloud from the service client device;
creating a private virtual machine based on the host hypervisor; and
providing the private virtual machine to the service client device.

3. The method of claim 2, further comprising:
connecting a virtual desktop with the service client device through a virtual desktop service connection manager.

4. The method of claim 3, wherein installing the guest hypervisor comprises:
activating a host-passthrough function in order to enable the host virtual machine to directly access a hardware resource.

5. The method of claim 4, wherein the method for providing a virtual desktop service is configured to support a web-based virtual desktop service in order to enhance security.

6. The method of claim 5, wherein the web-based virtual desktop service is based on HTML5.

7. An apparatus for providing a virtual desktop service, comprising:
a communication unit for receiving a request for a virtual machine based on a public cloud from a service client device and providing a public virtual machine to the service client device in response to the request; and
a public virtual machine management unit for allocating a host virtual machine based on Infrastructure-as-a-Service (IaaS) of a public cloud in response to the request for the virtual machine based on the public cloud, installing a guest hypervisor on the host virtual machine, and creating a public virtual machine based on the guest hypervisor.

8. The apparatus of claim 7, wherein the communication unit receives a request for a virtual machine based on a private cloud from the service client device and provides a private virtual machine to the service client device in response to the request,
further comprising:
a private virtual machine management unit for installing a host hypervisor and creating a private virtual machine based on the host hypervisor in response to the request for the virtual machine based on the private cloud.

9. The apparatus of claim 8, further comprising:
a virtual desktop service connection management unit for connecting a virtual desktop with the service client device.

10. The apparatus of claim 9, wherein the host virtual machine uses a host-passthrough function for direct access to a hardware resource of the apparatus for providing a virtual desktop service.

11. The apparatus of claim 10, further comprising:
a web service management unit for supporting a web-based virtual desktop service in order to enhance security.

12. The apparatus of claim 11, wherein the web-based virtual desktop service is based on HTML5.

13. A service client device, comprising:
a communication unit for sending a request for a virtual machine based on a public cloud to a virtual desktop service provision apparatus and being provided with a public virtual machine from the virtual desktop service provision apparatus; and
a virtual machine execution unit for running the public virtual machine,
wherein in response to the request for the virtual machine based on the public cloud, the virtual desktop service provision apparatus allocates a host virtual machine based on Infrastructure-as-a-Service (IaaS) of a public cloud, and the public virtual machine is created based on a guest hypervisor installed on the host virtual machine.

14. The service client device of claim 13, wherein:
the communication unit sends a request for a virtual machine based on a private cloud to the virtual desktop service provision apparatus and is provided with a private virtual machine from the virtual desktop service provision apparatus,
the virtual machine execution unit runs the private virtual machine, and
the private virtual machine is created based on a host hypervisor installed in the virtual desktop service provision apparatus in response to the request for the virtual machine based on the private cloud.

15. The service client device of claim 14, wherein the service client device is connected with a virtual desktop through a virtual desktop service connection management unit of the virtual desktop service provision apparatus.

16. The service client device of claim 15, wherein the host virtual machine uses a host-passthrough function in order to directly access a hardware resource of the virtual desktop service provision apparatus.

17. The service client device of claim 16, wherein:
the communication unit is provided with a web-based virtual desktop service that is supported through a web service management unit of the virtual desktop service provision apparatus in order to enhance security, and
the virtual machine execution unit supports the web-based virtual desktop service.

18. The service client device of claim 17, wherein the web-based virtual desktop service is based on HTML5.
